(19) United States
(12) Patent Application Publication
(10) Pub. No.: US 2016/0274570 A1
(43) Pub. Date: Sep. 22, 2016

(54) Method of virtual metrology using combined models

(71) Applicant: UNITED MICROELECTRONICS CORP., Hsin-Chu City (TW)

(72) Inventors: Lian-Hua Shih, Chiayi City (TW); Ching-Hsing Hsieh, Hsinchu County (TW); Feng-Chi Chung, Miaoli County (TW); Chia-Chi Chang, Tainan City (TW); Yu-Cheng Lin, Tainan City (TW); Sian-Jhu Tsai, Taipei City (TW); Meng-Chih Chang, Kaohsiung City (TW); Yi-Hui Tseng, Taoyuan City (TW)

(21) Appl. No.: 14/660,961

(22) Filed: Mar. 18, 2015

(51) Int. Cl. G05B 19/4097; G05B 15/02

(52) U.S. Cl. CPC G05B 19/4097; G05B 15/02; G05B 2219/37452

(57) ABSTRACT

A method of virtual metrology is disclosed. Process data and measurement values corresponding to a workpiece are collected. The process data and the measurement values are used to establish a conjecture model. A theoretical model corresponding to the workpiece and the conjecture model is used to establish another conjecture model. The another conjecture model is used to establish a virtual metrology value. The virtual metrology value is used to predict properties of a subsequently manufactured workpiece.

### BACKGROUND OF THE INVENTION

1. Field of the Invention

The present invention presents a method of virtual metrology using combined models, more particularly, a method of virtual metrology using a combination of a statistical model and a theoretical model to calculate virtual metrology values.

2. Description of the Prior Art

As device dimensions shrink, tighter process control is needed for advanced technology. Lot to lot advanced process control (APC) is widely implemented in semiconductor fabrication. Wafer to wafer control is needed for critical stages. Hence, plenty of metrology tools are needed. Cost and production cycle time is also increasing significantly due to metrology tools. However, operation efficiency and cost are the key components for semiconductor fabrication competitiveness. Therefore, a method of virtual metrology to perform wafer to wafer control economically without additional real metrology is needed to be developed.

### SUMMARY OF THE INVENTION

An embodiment of the present invention presents a method of virtual metrology. The method comprises collecting process data corresponding to a workpiece, collecting measurement values corresponding to the workpiece, calculating a first virtual metrology value of the workpiece according to a first conjecture model, correcting the first conjecture model according to the process data and the measurement values corresponding to the workpiece to form a second conjecture model, calculating a second virtual metrology value for the workpiece according to the second conjecture model, establishing a third conjecture model according to the second conjecture model and a theoretical model corresponding to a production process of the workpiece, calculating a third virtual metrology value for the workpiece according to the third conjecture model, and using the third virtual metrology value to predict properties of a subsequent workpiece manufactured.

Another embodiment of the present invention presents a method of virtual metrology. The method comprises collecting process data corresponding to a workpiece, collecting measurement values corresponding to the workpiece, establishing a first conjecture model according to the process data and the measurement values, establishing a second conjecture model according to the first conjecture model and a theoretical model corresponding to a production process of the workpiece, calculating a virtual metrology values of the workpiece according to the second conjecture model, and using the virtual metrology value to predict properties of a subsequent workpiece manufactured.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a virtual metrology system according to an embodiment of the present invention.

FIG. 2 illustrates a flowchart of a method of virtual metrology using combined models according to an embodiment of the present invention.

FIG. 3 illustrates a flowchart of a method of virtual metrology using combined models according to another embodiment of the present invention.

FIG. 4 illustrates a flowchart of a method for generating a combined model according to an embodiment of the present invention.

### DETAILED DESCRIPTION

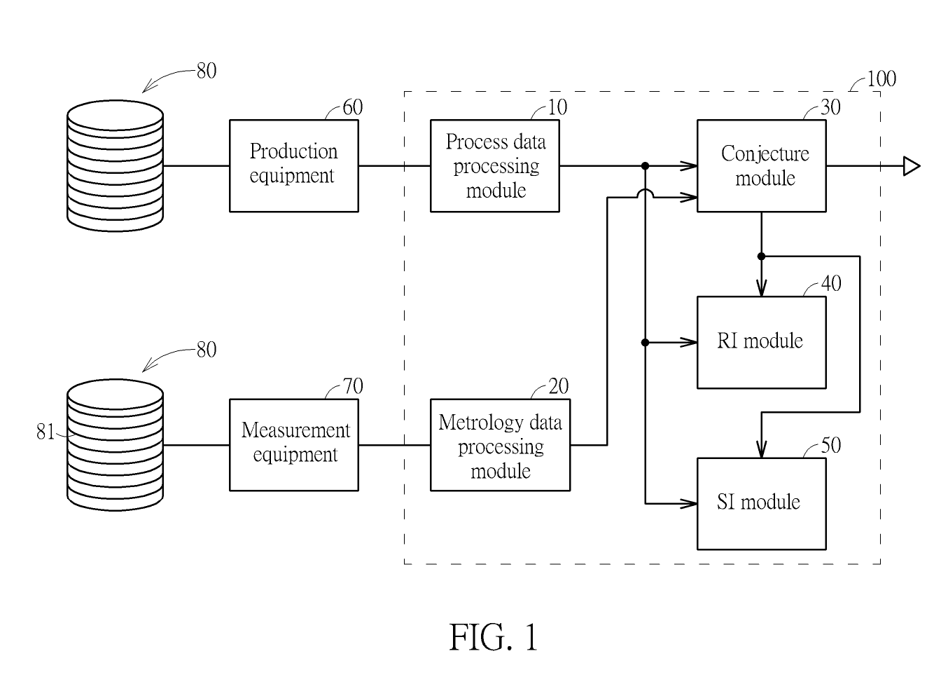

FIG. 1 illustrates a block diagram of a virtual metrology system according to an embodiment of the present invention. The metrology system 100 may comprise a process data processing module 10, a metrology data processing module 20, a conjecture module 30, a reliance index (RI) module 40, and a similarity index (SI) module 50. The process data processing module 10 may process and standardize raw process data from the production equipment 60. The process data processing module 10 may also be used to select important parameters from all of the parameters of the process data. The process data may correspond to a plurality of workpieces 80. The metrology data processing module 20 may process measurement values from the measurement equipment 70 to filter anomalous measurement data. The measurement values may correspond to at least one workpiece 81. The process data may be process characterized parameters (i.e. different physical conditions or properties) executed by the manufacturing equipment. The parameters maybe obtained by sensors and/or operation parameters of the equipment. The process data may, for example, include pressure, temperature, radio frequency (RF) power, RF reflection power of the chamber, flow rate throttle valve setting, manufacturing time and so forth. The measurement values may, for example, include wafer thickness, particle quantity, wafer curvature, and so forth. The conjecture module 30 may be used to calculate virtual metrology values of the plurality of workpieces 80 according to statistical models and theoretical models. Conjecture algorithms may be applied to the statistical models and the theoretical models to calculate the virtual metrology values. The conjecture algorithms may be a prediction algorithm such as a multi-regression algorithm or a neural network algorithm. The statistical models maybe generated using a plurality of sets of historical process data and a plurality of sets of historical measurement data. The theoretical models may be generated according to physics and/or chemistry theories corresponding to the process.

The reliance index module 40 may be used to generate reliance value to estimate reliance of the virtual metrology values. The similarity index module 50 may be used to determine the degree of similarity between current process data and historical process data. A reference model may be generated according to the reliance value of the virtual metrology values and the degree of similarity between current process data and historical process data.

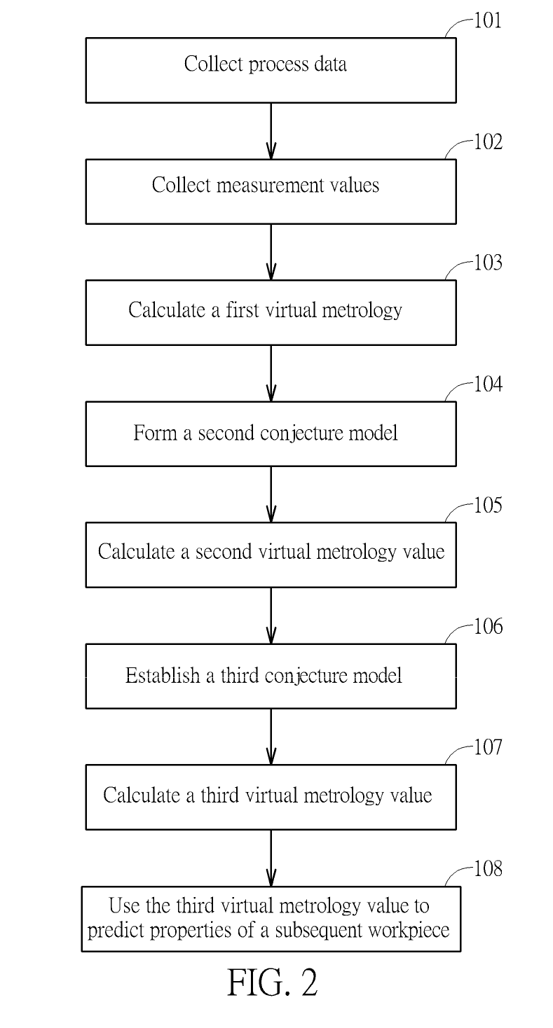

FIG. 2 illustrates a flowchart of a method of virtual metrology using combined models according to an embodiment of the present invention. The method may include but is not limited to the following steps or execution order:

Step 101: collect process data corresponding to a workpiece;

Step 102: collect measurement values corresponding to the workpiece;

Step 103: calculate a first virtual metrology value of the workpiece according to a first conjecture model;

Step 104: correct the first conjecture model according to the process data and the measurement values corresponding to the workpiece to form a second conjecture model;

Step 105: calculate a second virtual metrology value for the workpiece according to the second conjecture model;

Step 106: establish a third conjecture model according to the second conjecture model and a theoretical model corresponding to a production process of the workpiece;

Step 107: calculate a third virtual metrology value for the workpiece according to the third conjecture model; and

Step 108: use the third virtual metrology value to predict properties of a subsequently manufactured workpiece.

In step 101, process data corresponding to a workpiece may be collected. And in step 102, measurement values corresponding to the workpiece may be collected. The process data may be process characterized parameters (i.e. different physical conditions or properties) executed by the manufacturing equipment. The parameters may be obtained by sensors and/or operation parameters of the equipment. The process data may, for example, include pressure, temperature, RF power, RF reflection power of the chamber, flow rate throttle valve setting, manufacturing time and so forth. The measurement values may, for example, include wafer thickness, particle quantity, wafer curvature, and so forth.

A first conjecture model may be established according to the historical process data and the historical measurement values using a conjecture algorithm. The first conjecture model may be a statistical model. In some embodiments, a reference model corresponding to values generated using the reliance index module and the similarity index module may also be established.

In step 103, a first virtual metrology value of the workpiece may be calculated according to the first conjecture model. The accuracy of the first virtual metrology value may be increased by generating the first virtual metrology value according to the first conjecture model and the reference model. Since the first virtual metrology value may be generated without using the current process data and measurement data, the first virtual metrology value may be delivered promptly.

In step 104, the first conjecture model may be corrected according to the process data and the measurement values corresponding to the workpiece to form a second conjecture model. In step 105, a second virtual metrology value for the workpiece may be calculated according to the second conjecture model. Since the second virtual metrology value may be generated using the first conjecture model, the current process data and measurement data, the second virtual metrology value may be more accurate as compared to the first virtual metrology.

In step 106, a third conjecture model may be established according to the second conjecture model and a theoretical model corresponding to a production process of the workpiece. The theoretical model may be based on the scientific theory behind the physical and/or chemical reaction happening during the production process of the workpiece.

In step 107, a third virtual metrology value for the workpiece may be calculated according to the third conjecture model. Thus, in step 108, the third virtual metrology value may be used to predict properties of a subsequently manufactured workpiece. Since the third virtual metrology value is calculated according to the second conjecture model and a theoretical model, the third virtual metrology value may be have a higher accuracy than the first metrology value and second metrology value.

Furthermore, the third virtual metrology value maybe compared with a plurality of patterns. When the third virtual metrology value meets one of the plurality of patterns, a normal sampling step may be performed. When the third virtual metrology value does not meet any of the plurality of patterns, an abnormal processing step may be performed. The abnormal processing step maybe dynamically adding a new pattern according to the third virtual metrology value. And, the first conjecture model may be updated by adding the process data and the measurement values corresponding to the workpiece to historical process data and historical measurement values of the first conjecture model.

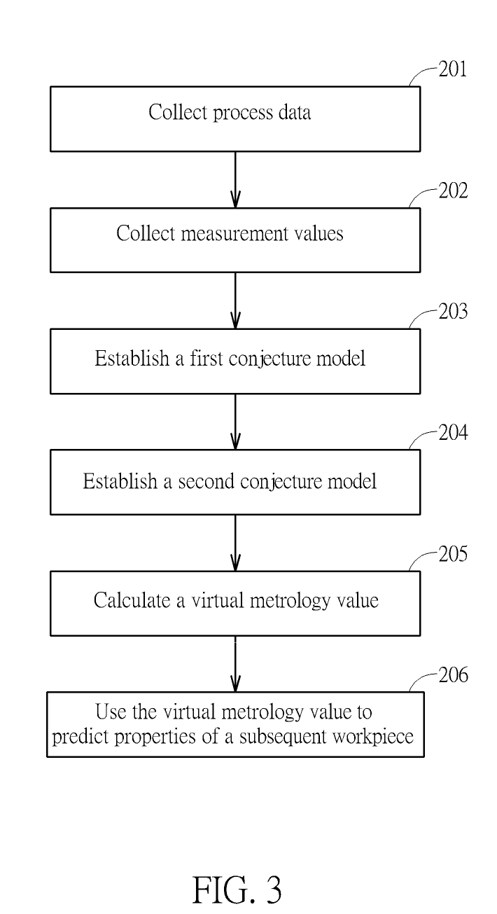

FIG. 3 illustrates a flowchart of a method of virtual metrology using combined models according to another embodiment of the present invention. The method may include but is not limited to the following steps or execution order:

Step 201: collect process data corresponding to a workpiece;

Step 202: collect measurement values corresponding to the workpiece;

Step 203: establish a first conjecture model according to the process data and the measurement values;

Step 204: establish a second conjecture model according to the first conjecture model and a theoretical model corresponding to a production process of the workpiece;

Step 205: calculate a virtual metrology value of the workpiece according to the second conjecture model; and

Step 206: use the virtual metrology value to predict properties of a subsequently manufactured workpiece.

In step 201, process data corresponding to a workpiece may be collected. And in step 202, measurement values corresponding to the workpiece may be collected. The process data may be process characterized parameters (i.e. different physical conditions or properties) executed by the manufacturing equipment. The parameters may be obtained by sensors and/or operation parameters of the equipment. The process data may, for example, include pressure, temperature, RF power, RF reflection power of the chamber, flow rate throttle valve setting, manufacturing time and so forth. The measurement values may, for example, include wafer thickness, particle quantity, wafer curvature, and so forth.

In step 203, a first conjecture model may be established according to the process data and the measurement values using a conjecture algorithm. The first conjecture model maybe a statistical model. In some embodiments, a reference model corresponding to values generated using the reliance index module and the similarity index module may be established. And the reference model may be used in combination with the process data and the measurement values to establish a first conjecture model.

In step 204, a second conjecture model may be established according to the first conjecture model and a theoretical model corresponding to a production process of the workpiece. The theoretical model may be based on the scientific theory behind the physical and/or chemical reaction happening during the production process of the workpiece.

In step 205, a virtual metrology value of the workpiece may be calculated according to the second conjecture model. Thus, instep 206, the virtual metrology value may be used to predict properties of a subsequent workpiece manufactured.

Furthermore, the virtual metrology value maybe compared with a plurality of patterns. When the virtual metrology value meets one of the plurality of patterns, a normal sampling step maybe performed. When the virtual metrology value does not meet any of the plurality of patterns, an abnormal processing step may be performed. The abnormal processing step may be dynamically adding a new pattern according to the virtual metrology value. And, the first conjecture model may be updated by adding the process data and the measurement values corresponding to the workpiece to historical process data and historical measurement values of the first conjecture model.

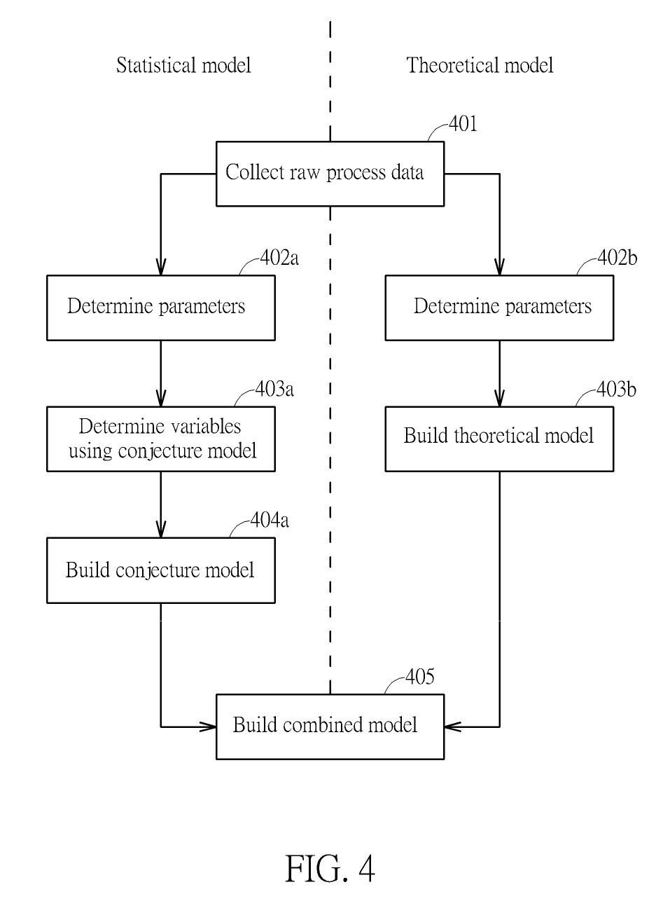

FIG. 4 illustrates a flowchart of a method for generating a combined model according to an embodiment of the present invention. For example, when calculating for virtual metrology values for a chemical vapor deposition (CVD) process, a combination of a statistical model and a theoretical model may be used.

The statistical model maybe a conjecture model. To obtain the statistical model, raw process data may be collected (step 401). Parameters corresponding to the raw process data may then be calculated (step 402a). Parameters may correspond to mean, max, min or standard deviation of the raw process data. A conjecture algorithm such as stepwise regression, partial least squares regression, and so forth may be used to determine important variables (step 403a). And, according to the important variables, the conjecture model may be built (step 404a). An example of a conjecture model may be as follows:

VM(Y)=A1X1+A2X3+A3X5+A4X6+A5X7+A6X8+A0

where:

VM(Y) may be a metrology value;

X1, X3, X5, X6, X7, and X8 may be a set of process data; and

A1, A2, A3, A4, A5, A6, and A0 maybe mean coefficients corresponding to the set of process data.

The set of process data may comprise different process data. The different process data may have different corresponding mean coefficients. The set of process data may have a corresponding set of measurement values. The process data maybe process characterized parameters (i.e. different physical conditions or properties) executed by the manufacturing equipment. The parameters may be obtained by sensors and/or operation parameters of the equipment. The process data may, for example, include pressure, temperature, RF power, RF reflection power of the chamber, flow rate throttle valve setting, manufacturing time and so forth. The measurement values may, for example, include wafer thickness, particle quantity, wafer curvature, and so forth. In an embodiment, the set of process data may correspond to current process data and historical process data. In another embodiment the set of process data may correspond to only historical process data.

To obtain the theoretical model, raw process data may be collected (step 401). Factors may be determined by relating the raw process data using physics or chemistry (step 402a). For example, natural log may be determined according to the relation between the raw process data and decreasing temperature. And, according to the factors determined, a mathematical equation may be derived according to the relation (step 403a). The mathematical equation may be the theoretical model. An example of a theoretical model may be as follows:

R=Ae^{-Ea/(RT)}[A]^{m}[B]ⁿ

where:

R may be a reaction rate;

Ae^{-Ea/(RT)} may be an equation for a rate constant having A as a frequency factor and e^{-Ea/(RT)} as a fraction of collisions with sufficient enegergy;

[A] and [B] may be concentrations of reactants;

m may be an order of reaction for A; and

n may be an order of reaction for B.

A combined model maybe built by combining the statistical model and the theoretical model (step 405). A virtual metrology value may be calculated by inputting a current set of process data to the combined model. In some embodiments, to further increase the accuracy of the calculation of virtual metrology values, a reference model may be established according to the historical process data and historical measurement values. Note that a reference algorithm used to establish the reference model maybe different from the conjecture algorithm used to establish the conjecture model. The virtual metrology values calculated according to the set of process data and the corresponding set of measurement value may be used to establish a pattern. The pattern may be compared to a plurality of patterns previously generated. When the virtual metrology value meets one of the plurality of patterns, a normal sampling step may be performed. When the virtual metrology value does not meet any of the plurality of patterns, an abnormal processing step may be performed. The abnormal processing step may be dynamically adding a new pattern according to the virtual metrology value.

The present invention presents a method of virtual metrology. The method of virtual metrology may be used to predict properties of a workpiece based on historical process data and measurement values without directly performing physical measurements on the workpiece. Performing physical measurements may be costly due to the need for metrology equipments and time consuming since all of the workpieces processed need to be physically measured. The method of virtual metrology presented uses a combination of statistical model and the theoretical model to form a combined model. The statistical model and the theoretical model may be built simultaneously or concurrently. The statistical model may only account for the pattern of the workpieces fabricated through time. The theoretical model may be used to account for the expected behavior of the materials used in the fabrication of the workpiece according to scientific background such as physics and/or chemistry. Thus, by using a combined model, the accuracy of the metrology value may significantly be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of virtual metrology, comprising:
collecting process data corresponding to a workpiece;
collecting measurement values corresponding to the workpiece;
calculating a first virtual metrology value of the workpiece according to a first conjecture model;
correcting the first conjecture model according to the process data and the measurement values corresponding to the workpiece to form a second conjecture model;
calculating a second virtual metrology value for the workpiece according to the second conjecture model;
establishing a third conjecture model according to the second conjecture model and a theoretical model corresponding to a production process of the workpiece;
calculating a third virtual metrology value for the workpiece according to the third conjecture model; and
using the third virtual metrology value to predict properties of a subsequently manufactured workpiece.

2. The method of claim 1, further comprising:
establishing the first conjecture model according to the historical process data and the historical measurement values using a conjecture algorithm.

3. The method of claim 1, further comprising:
comparing the third virtual metrology value with a plurality of patterns;
when the third virtual metrology value meets one of the plurality of patterns, performing a normal sampling step; and
when the third virtual metrology value does not meet any of the plurality of patterns, performing an abnormal processing step.

4. The method of claim 3, wherein performing the abnormal processing step is dynamically adding a new pattern according to the third virtual metrology value.

5. The method of claim 1, further comprising:
updating the first conjecture model by adding the process data and the measurement values corresponding to the workpiece to historical process data and historical measurement values of the first conjecture model.

6. The method of claim 1, establishing the third conjecture model further comprises:
establishing a reference model according to the historical process data and the historical measurement values using a reference algorithm; and
establishing the third conjecture model according to the second conjecture model, the reference model and the theoretical model.

7. A method of virtual metrology, comprising:
collecting process data corresponding to a workpiece;
collecting measurement values corresponding to the workpiece;
establishing a first conjecture model according to the process data and the measurement values;
establishing a second conjecture model according to the first conjecture model and a theoretical model corresponding to a production process of the workpiece;
calculating a virtual metrology value of the workpiece according to the second conjecture model; and
using the virtual metrology value to predict properties of a subsequent workpiece manufactured.

8. The method of claim 7, further comprising:
establishing the first conjecture model using a conjecture algorithm.

9. The method of claim 7, further comprising:
comparing the virtual metrology value with a plurality of patterns;
when the virtual metrology value meets one of the plurality of patterns, performing a normal sampling step; and
when the virtual metrology value do not meet any of the plurality of patterns, performing an abnormal processing step.

10. The method of claim 9, wherein performing the abnormal processing step is dynamically adding a new pattern according to the virtual metrology value.

11. The method of claim 7, wherein establishing the first conjecture model according to the process data and the measurement values is establishing the first conjecture model by adding the process data and the measurement values corresponding to the workpiece to historical process data and historical measurement values.

12. The method of claim 7, establishing the second conjecture model further comprises:
establishing a reference model according to the historical process data and the historical measurement values using a reference algorithm; and
establishing the second conjecture model according to the first conjecture model, the reference model and the theoretical model.
